(19) United States
(12) Patent Application Publication
(10) Pub. No.: US 2006/0035736 A1
(43) Pub. Date: Feb. 16, 2006

(54) Engine belt-driven system

(75) Inventors: Atsushi Umeda, Okazaki-shi (JP); Tsutomu Shiga, Nukata-gun (JP); Kouichi Ihata, Okazaki-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/198,136

(22) Filed: Aug. 8, 2005

(30) Foreign Application Priority Data
Aug. 6, 2004 (JP) 2004-230742

(51) Int. Cl. F16H 61/00; F16H 59/00

(52) U.S. Cl. 474/70; 474/50; 474/87

(57) ABSTRACT

The engine belt-driven system includes a plurality of auxiliaries including a vehicle generator, and a V-ribbed belt transmitting torque from a vehicle engine to said plurality of said auxiliaries. The vehicle generator is provided with a dynamic absorber having an inertia moment smaller than an inertia moment of a rotor of said vehicle generator. The dynamic absorber may be mounted to an end surface of the rotor.

### CROSS-REFERENCE TO RELATED APPLICATION

This application is related to Japanese Patent Application No. 2004-230742 filed on Aug. 6, 2004, the contents of which are hereby incorporated by reference.

### BACKGROUND OF THE INVENTION

1. Field of the Invention

The present invention relates to an engine belt-driven system in which a plurality of auxiliaries including a vehicle alternator (vehicle generator) are belt-driven by a vehicle engine.

2. Description of Related Art

It was common that a vehicle auxiliary such as a vehicle alternator (referred to as simply alternator hereinafter) is driven by a vehicle engine through a V-belt having a V-shaped cross section, and that the alternator is driven with a step-up ratio of at most 2 because of belt slippage. It was a big challenge to reduce the engine vibration for the purpose of stabilizing the engine belt-driven system, thereby providing quiet vehicles.

It was known that the vehicle engine becomes unstable when a vehicle auxiliary having a large inertia moment exhibits low behavioral stability in the engine belt-driven system.

The alternator has a large inertia moment and is driven with a high step-up ratio compared to other vehicle auxiliaries. Accordingly, stabilizing the rotation of the alternator leads to stabilizing the rotation of the vehicle engine. For such reason, it has been studied to suppress the variation of the rotational speed of the alternator.

Generally, methods for suppressing vibration can be used as methods for suppressing rotational speed variation. Such methods include (1) stabilizing a vibration source by use of a dynamic vibration absorber (referred to as dynamic absorber hereinafter), and (2) insulating the vibration produced by the vibration source.

The dynamic absorber used in the method (1) can be constituted by a mass body having a mass about one tenth of that of the vibration source, and an elastic body hating a spring constant and a damping constant matched to a target resonance frequency.

However, the method (1) had a problem in that it requires a mass as large as about one tenth of the alternator. In addition, the dynamic absorber had to be installed on the front end or the rear end of the alternator, because the alternator is provided with a cooling fan installed between its bearing and pulley. Accordingly, using the method (1) increased the axial length of the alternator. Also it lowered the durability of the alternator, because the alternator was attached with a substantial mass at a portion distant from its mass center, that results in the alternator bending.

Furthermore, in order to estimate what value the resonance frequency has, the method (1) requires performing numerical analysis for finding eigen values of motion equations of fifth or higher degree which cannot be solved theoretically in a case where the engine belt-driven system has five or more axes (belt-driven auxiliaries). It was practically impossible to perform such a numerical analysis even by use of a computer.

The method (2) uses an elastic member disposed in a transmission path of vibration to attenuate the vibration. Examples of the method (2) include using a combination of a one-way clutch and a pulley, and using a combination of a damper and a pulley.

With this method (2), the torque due to the rotational speed variation of the alternator is absorbed (insulated) by the one-way clutch or the damper, and thereby the engine belt-driven system is stabilized. The method (2) has been the mainstream of stabilizing the engine belt-driven system, because it does not require performing any complex numerical analysis.

Examples thereof include providing the alternator with a one-way clutch 100 within a pulley 100 as shown in FIG. 9 (refer to Japanese Patent Application Laid-open No. 61-228153 for detail), and providing the alternator with a damper pulley 130 having an elastic member such as a torsion spring 120 thereinside as shown in FIG. 10 (refer to Published Japanese Translation No. 2001-523325 for PCT application for detail).

Incidentally, in recent years, V-ribbed belts with ribs having V-shaped cross sections formed on their driving surface are replacing the conventional V-belts. The V-ribbed belt allows the auxiliaries to be belt-driven with higher step-up ratios because of its low slippage characteristics.

The step-up ratio of an auxiliary is determined by a ratio of the diameter of a crank pulley of the vehicle engine to the diameter of a driven pulley of the auxiliary. Generally, the crank pulley is made to have a small diameter (190 mm at most) in order to avoid belt slippage or breakage by an excessive centrifugal force. Since the output power of the alternator increases with the increase of its rotational speed, it is possible to downsize the alternator when it is driven with a high step-up ratio.

However, since, when an auxiliary is sped up, it has an equivalent inertia moment equal to its actual inertia moment multiplied by the square of the step-up ratio, although the actual inertia moment of the alternator can be reduced with the increase of the step-up ratio, the equivalent inertia moment of the alternator increases in proportion to the square of the step-up ratio.

Hence, if the alternator is driven with the step-up ratio as large as between 2 and 3, the equivalent inertia moment of the alternator becomes the largest factor in the unstableness of the engine belt-driven system. Especially, in the serpentine belt-driven system where a plurality of auxiliaries are driven through the same belt, its instability becomes worse, because the serpentine belt system is a multi-axis system, and has as many resonance points as there are axes (auxiliaries). As a result, the rotational speed variation and belt flapping in the case of using the V-ribbed belt becomes more serious than the case of using the conventional V-belt.

Engine belt-driven systems using such a V-ribbed belt have a problem in that it is difficult to provide a space large enough to accommodate the one-way clutch or elastic member as explained with reference to FIG. 9 or FIG. 10 within the alternator, and accordingly it is difficult to use the method (2), because the outer diameter of the pulley of the alternator is made small when the alternator is designed to be driven by the V-ribbed belt.

Typically, the outer diameter of the pulley is between 70 mm and 100 mm in the case of V-belt, while it is between 50 mm and 65 mm in the case of V-ribbed belt. The outer diameter of a usable space available within the pulley is equal to the outer diameter of the pulley subtracted by the depth of its grooves and its radial thickness.

In the case of the V-belt pulley whose outer diameter is between 70 mm and 100 mm, the diameter of the usable space is between 47 mm and 77 mm, when the depth of its grooves is at the typical value of 9 mm and its radial thickness is at the typical value of 2.5 mm While, in the case of the V-ribbed belt pulley whose outer diameter is between 50 mm and 65 mm, the diameter of the usable space is between 38 mm and 53 mm, when the depth of its grooves is at the typical value of 3.3 mm and its radial thickness is at the typical value of 2.5 mm

Accordingly, in the case of the V-ribbed belt pulley, it is difficult for the one-way clutch and the spring to have enough cross-sectional areas, though they are applied with torque larger than in the case of the V-belt pulley.

Incidentally, the above mentioned Published Japanese Translation No. 2001-523325 suggests using a slide spring which does not occupy a large space. However, it involves a problem of wear in sliding portions. In addition, it requires detailed and laborious spring design, which removes the advantage of the method (2) in design ease.

### SUMMARY OF THE INVENTION

The present invention provides an engine belt-driven system including:
a plurality of auxiliaries including a vehicle generator; and
a V-ribbed belt transmitting torque from a vehicle engine to said plurality of said auxiliaries,
wherein said vehicle generator is provided with a dynamic absorber having an inertia moment smaller than an inertia moment of a rotor of said vehicle generator.

With the present invention, it is possible to improve the stability of engine belt-driven system without a sacrifice of the durability of the vehicle alternator, because the vehicle generator having a large inertial moment is provided with the dynamic absorber, and the dynamic absorber has a small inertial moment, so that the constituent elements of the dynamic absorber can be made to have large safety margins.

### BRIEF DESCRIPTION OF THE DRAWINGS

In the accompanying drawings:

FIG. 1 is a layout diagram of an engine driven system according to a first embodiment of the invention;

FIG. 2 is a cross-sectional view of an alternator included in the engine driven system according to the first embodiment of the invention;

FIG. 3 is a plan view of a dynamic absorber included in the alternator of the engine driven system according to the first embodiment of the invention;

FIG. 4 is a graph showing results of resonance analysis made on the alternator of the engine driven system according to the first embodiment;

FIG. 5 is a cross-sectional view of an alternator of an engine driven system according to a second embodiment of the invention.

FIG. 6 is a partial cross-sectional view of an alternator of an engine driven system according to a third embodiment of the invention;

FIG. 7 is a diagram showing a cross section of a portion of an alternator near its pulley of an engine driven system according to a fourth embodiment of the invention;

FIG. 8 is a diagram showing a cross section of a portion of an alternator near its pulley of an engine driven system according to a fifth embodiment of the invention;

FIG. 9 is a cross-sectional view of a conventional alternator provided with a one-way clutch; and

FIG. 10 is a diagram showing a cross section of a damper pulley installed in a conventional alternator.

### PREFERRED EMBODIMENTS OF THE INVENTION

### First Embodiment

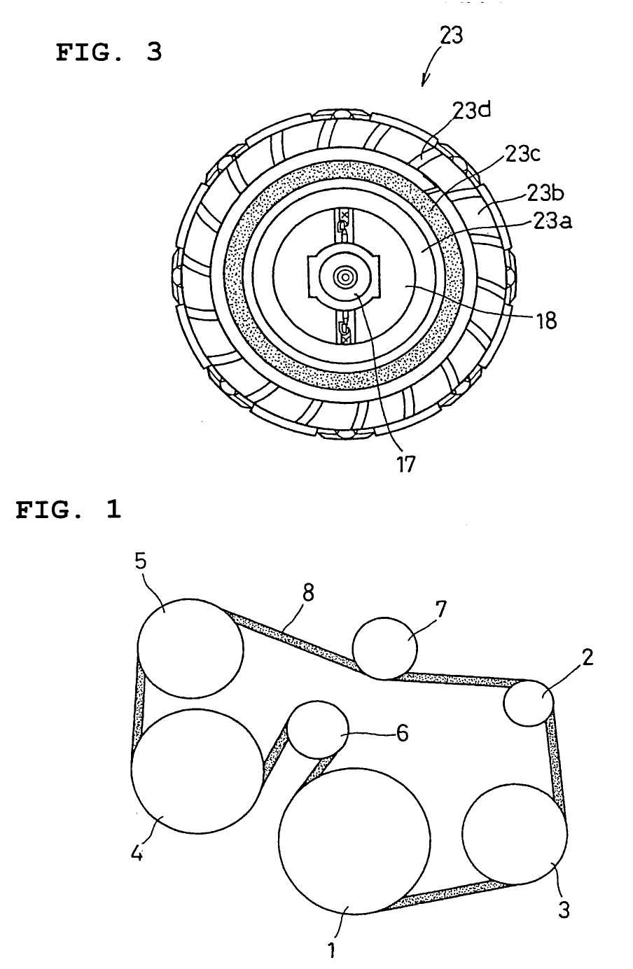

FIG. 1 is a layout diagram of an engine driven system according to a first embodiment of the invention. The engine driven system includes an alternator 2, an air conditioner compressor 3, a water pump 4, and a power steering hydraulic pump 5 as auxiliaries which are belt-driven by a vehicle engine 1. The engine driven system further includes an auto tensioner 6, and a V-ribbed belt 8 which couples pulleys of these auxiliaries to a crank pulley of the engine 1. This engine driven system is a serpentine belt-driven system.

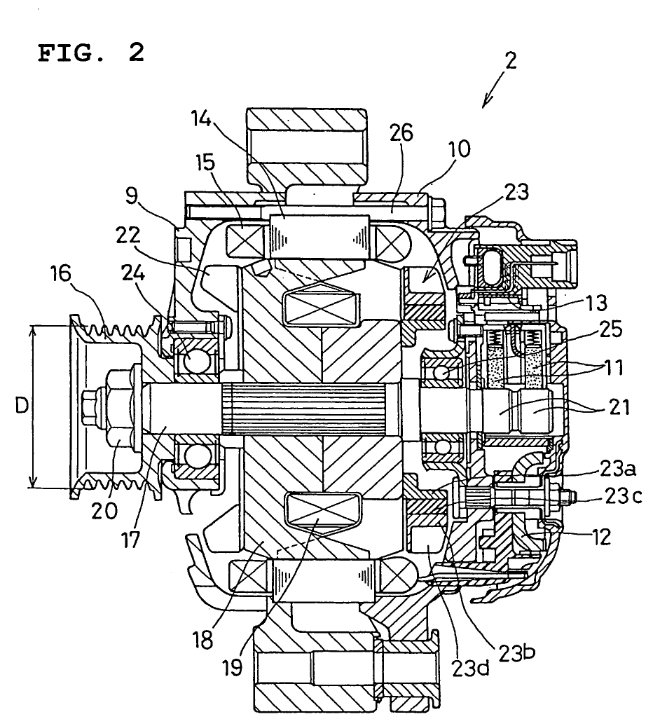

FIG. 2 is a cross-sectional view of the alternator 2. The alternator 2 includes a stator, a rotor, a front housing member 9, a rear housing member 10, a brush 11, a rectifier 12, and a voltage regulator 13. The stator includes an annular stator core 14, and an armature winding 15 wound around the stator core 14. When the rotor rotates, an AC voltage is induced in the armature winding 15.

The rotor includes a rotating shaft 17 to which the rotational driving force of the engine 1 is transmitted through a pulley 16, a rotor core (Lundel type pole core) 18 wound around the rotating shaft 17, and a field winding 19 wound around the rotor core 18.

The pulley 16 is secured to one end of the rotating shaft 17 by a nut 20. The pulley 16 has a plurality of parallel grooves having a V-shaped cross section formed on its circumference. The outer diameter of the pulley 16 is smaller than 59 mm. The rotating shaft 17 is provided with a pair of slip rings 21 at the other end thereof. A cooling fan 22 which rotates integrally with the rotator core 18 for creating a cooling wind is fixed to the pulley side end surface of the rotator core 18. A dynamic absorber 23 is fixed to the non-pulley side end surface of the rotating shaft 18.

The front housing member 9 has a bearing 24 supporting one end of the rotating shaft 17, and the rear housing member 10 has a bearing 25 supporting the other end of the rotating shaft 17. The front and rear housing members 9, 10, between which the stator core 14 is held, are fastened to each other by a bolt 26. The brush 11, which is in a sliding contact with the slip rings 21, is for supplying a field current to the field winding 19. The rectifier 12 is for converting the AC voltage induced in the armature winding 15 into a DC voltage. The voltage regulator 13 is for controlling the output power by regulating the field current flowing through the field winding 19.

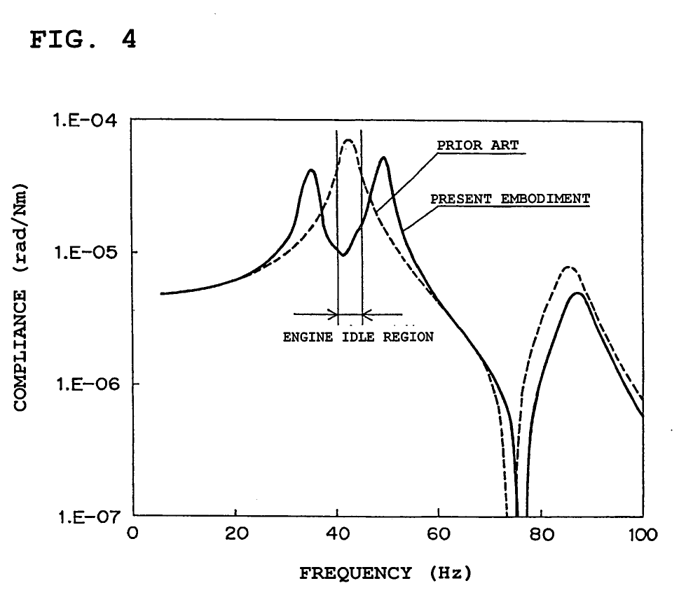

Next, the structure of the dynamic absorber 23 is explained referring to FIG. 3 which is a plan view of the dynamic absorber 23. The dynamic absorber 23 includes an inner annular ring 23a fixed to the non-pulley side end surface of the rotator shaft 18 by welding for example, an outer annular ring 23b disposed coaxially with the inner annular ring 23a, and an elastic member 23c which is made of a rubber, for example, and press-fitted between the inner and outer rings 23a, 23b. The elastic member 23c is capable of being displaced only in the torsional direction (the direction in which the rotor rotates). The inner and the outer rings 21a, 23b are displaced from each other when the elastic member 23c is displaced. The outer ring 23b has fan blades 23d integrally formed therein which create air resistance when the rotor rotates. The centrifugal wind created by the fan blades 23d is used for cooling the armature winding 15.

In the serpentine belt-driven system including a plurality of auxiliaries driven by the same engine, motion equations as many as the number of the axes (auxiliaries) hold. These motion equations are represented as the following simultaneous equations (1).

$${J}_{n} {\ddot{β}}_{n} = - {c}_{n} ( {R}_{n} {\dot{β}}_{n} - {R}_{n - 1} {\dot{β}}_{n - 1} ) {R}_{n} - {c}_{n + 1} ( {R}_{n} \dot{β} - {R}_{n + 1} {\dot{β}}_{n + 1} ) {R}_{n} - {κ}_{n} ( {R}_{n} {β}_{n} - {R}_{n - 1} {β}_{n - 1} ) {R}_{n} - {κ}_{n + 1} ( {R}_{n} {β}_{n} - {R}_{n + 1} {β}_{n + 1} ) {R}_{n} - {P}_{n} {R}_{n} \qquad ( 1 )$$

Jₙ: inertia moment of the n-th auxiliary
\ddot{β}ₙ: angular acceleration of the n-th auxiliary
\acute{β}ₙ: angular velocity of the n-th auxiliary
κₙ: belt spring constant upstream of the n-th auxiliary
κₙ₊₁: belt spring constant downstream of the n-th auxiliary
cₙ: belt damping factor upstream of the n-th auxiliary
cₙ₊₁: belt damping factor downstream of the n-th auxiliary
Pₙ: driving force of the n-th auxiliary
Rₙ: radius of the n-th auxiliary

The above simultaneous equations tell that the serpentine belt-driven system has eigen frequencies (resonance frequencies) as many as the number of the axes (the number of the auxiliaries).

When the frequency of the torque variation due to explosive combustion in engine cylinders matches any one of the resonance frequencies, a large rotational variation (resonance) develops in the serpentine belt-driven system. Especially, if the resonance occurs in the engine idle region, unpleasant vibration and noise due to the resonance become conspicuous, because there is not any vehicle travel vibration or vehicle travel noise in the engine idle region. Furthermore, such a rotational variation (resonance) force the belt to bear the burden, and the belt shortens its life accordingly.

It is known that the stability of the belt-driven system depends on the inertia moments of the auxiliaries or depend on the equivalent inertia moments of the auxiliaries when they are speeded up. The equivalent inertia moment is equal to the actual inertia moment multiplied by the value of the square of the step-up ratio (speed-up ratio), as shown in the following-equation (2).
Jeq=α²J . . . (2)
Jeq: equivalent inertia moment
α: step-up ratio
J: actual inertia moment

Accordingly, to stabilize the serpentine belt-driven system, it is efficient to take measures on the auxiliary that has the largest equivalent inertia moment. Hence, in this embodiment, the alternator 2 driven with a step-up ratio of as large as 2 to 3.5 is provided with the dynamic absorber.

Although it has been considered that it is practically impossible to provide the alternator with a dynamic absorber in the engine belt-driven system, because of the fact that the alternator has a large inertia moment, and that the exceedingly complex numerical analysis has to be performed for finding eigen values of the motion equations of fifth or higher degree.

However, the inventors have observed that providing the alternator with the dynamic absorber for stabilizing the belt-driven system is possible in the present day. This observation is based on the fact that the actual inertia moment of the alternator is small in the serpentine belt driven-system, since the alternator is belt-driven through the V-ribbed belt with a step-up ratio as large as 2 to 3.5, and the complex numerical analysis required for finding eigen values of the motion equations of fifth or higher degree can be performed without difficulty by use of the latest high performance computers.

Next, explanation of how the inertia moment and spring constant of the dynamic absorber 23 are determined is set forth below.

Although the serpentine belt-driven system is a multi-axis system having as many resonance points as there are axes (auxiliaries) as described above, in this embodiment, the inertia moment and spring constant of the dynamic absorber 23 are set to such values as to suppress the resonance in the engine idle region, because the resonance point in the engine idle region is most serious of all the resonance points in engine vehicles.

It is possible, through modeling by use of eigen vectors derived from the simultaneous equations (1), to determine the mode equivalent inertia moment Ji and mode equivalent spring constant Ki corresponding to the resonance frequency in question, although detailed explanation is omitted in the interest of simplicity.

The mode equivalent inertia moment Ji, the mode equivalent spring constant Ki, and the resonance frequency Ki satisfy the following equation (3).

$$fi = \frac{1}{2 π} \sqrt{\frac{Ki}{Ji}} \qquad ( 3 )$$

To give an example, in a 6-cylinder engine, since the frequency of the torque variation due to explosive combustion in the engine cylinders is three times the rotational frequency of the engine, if the idle rotational speed is between 800 rpm and 900 rpm, the frequency of the torque variation is between 40 Hz and 45 Hz.

FIG. 4 is a graph showing results of the resonance analysis made on the engine driven system of the first embodiment. The vertical axis of the graph represents compliance representing the magnitude of the transfer function. To be more precise, the vertical axis represents the magnitude of the displacement of the rotor of the alternator 2 when the crank shaft of the engine 1 is added with a torque of 1N/m. The horizontal axis of the graph represents the frequency of the torque variation.

The broken-line curve in the graph represents the compliance-frequency characteristic when the rotor of the alternator 2 is not provided with the dynamic absorber 23. As seen from FIG. 4, the compliance-frequency characteristic has a resonance point at the frequency of 42 Hz within the engine idle region.

The mode equivalent inertia moment Ji and the mode equivalent spring constant Ki corresponding to the resonance frequency of 42 Hz can be determined to be 0.0041 Kgm², and 289 Nm/Rad, respectively. The dimension and material of the elastic member 23c of the dynamic absorber 23 are determined as such that the following equations (4) hold.

$$\begin{matrix}Jdi = μ Ji \\ Kdi = Jdi \frac{Ki}{Ji} {( \frac{1}{1 + μ} )}^{2} \\ Cdi = 2 Jdi \sqrt{\frac{Ki}{Ji}} \sqrt{\frac{3 μ}{8 {( 1 + μ )}^{3}}}\end{matrix} \qquad ( 4 )$$

In this embodiment, the value of p is set at 0.1 so that the inertial moment of the dynamic absorber 23 is sufficiently smaller than that of the rotor of the alternator 2. More specifically, the dimension and material of the elastic member 23c of the dynamic absorber 23 are determined as such that Jdi equals to 0.00041 Kgm², Kdi equals to 23.8 Nm, and Cdi, which is a damping constant of the dynamic absorber 23 equals to 0.036 Ns/m.

The solid-line curve in the graph of FIG. 4 represents the compliance-frequency characteristic when the rotor of the alternator 2 is provided with the dynamic absorber 23. As seen from this graph, the 42-Hz vibration can be suppressed by providing the rotor core 18 of the alternator 2 with the dynamic absorber 23 designed to damp the 42-Hz vibration. Although a new resonance point shows up near 50 Hz, it does not cause any serious problem, because the new resonance point is not in the engine idle region but in the vehicle running region.

In this embodiment, the inertia moment of the dynamic absorber 23 is as small as about one tenth of that of the rotor. Accordingly, with this embodiment, the durability of the alternator can be improved greatly, because the constituent elements of the dynamic absorber 23 can be made to have large safety margins.

Furthermore, since the dynamic absorber 23 is installed in an idle space within the alternator 2 (the non-pulley side end surface of the rotor core 18), it is not necessary to upsize the alternator 2 to provide the alternator 2 with the dynamic absorber 23.

In addition, since the damping force of the dynamic absorber 23 is obtained as the air resistance of the fan blades 23d provided in its outer ring 23b, it is easy to design the dynamic absorber 23 to have a desired damping factor.

Furthermore, since the armature winding 15 is cooled efficiently by the centrifugal wind created by the fan blades 23d of the dynamic absorber 23, it is unnecessary to provide any additional cooling fan.

Although the dynamic absorber 23 is mounted to the non-pulley side end surface of the rotor core 18 in this embodiment, it may be mounted to the pulley-side end surface of the rotor core 18.

### Second Embodiment

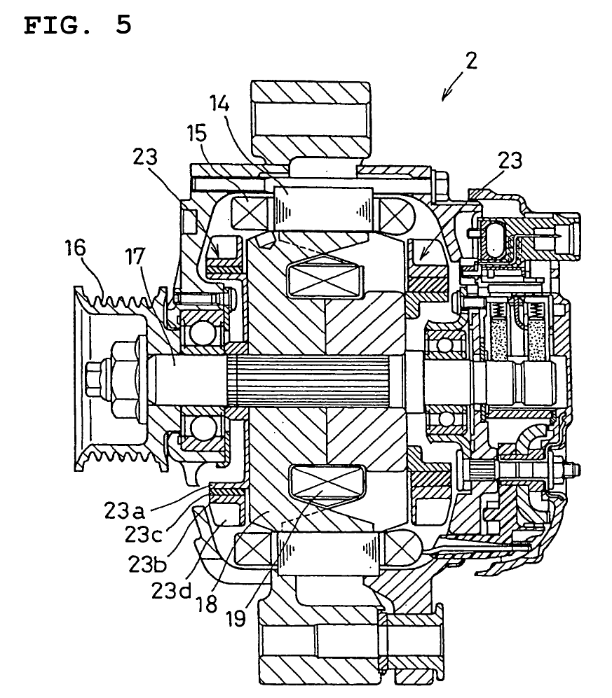

FIG. 5 is a cross-sectional view of an alternator 2 of an engine driven system according to a second embodiment of the invention. As shown in this figure, the alternator 2 of this embodiment has two dynamic absorbers 23 mounted to the both end surfaces of the rotor corer 18.

The alternator 2 of this embodiment has a still higher durability, because the inertia moment is spread to the both sides of the rotor core 18.

Incidentally, in this embodiment, it is necessary to change the spring constants of the dynamic absorbers 23 according to their masses.

The alternator of this embodiment has good self-cooling performance, since each of the dynamic dampers 23 has fan blades 23.

### Third Embodiment

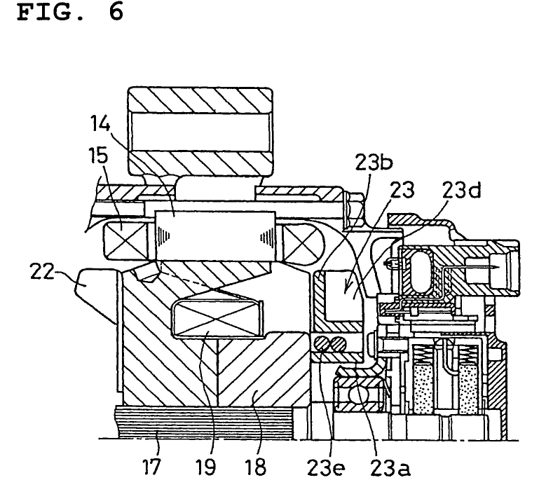

FIG. 6 is a partial cross-sectional view of an alternator 2 of an engine driven system according to a third embodiment of the invention. In the third embodiment, a torsion spring 23e is used as the elastic member of the dynamic absorber 23.

The spring 23e is configured to increase its tightness when compressed to have hysteresis characteristics. The dynamic absorber 23 is excellent at heat resistance, because it can be made of only metals.

### Fourth Embodiment

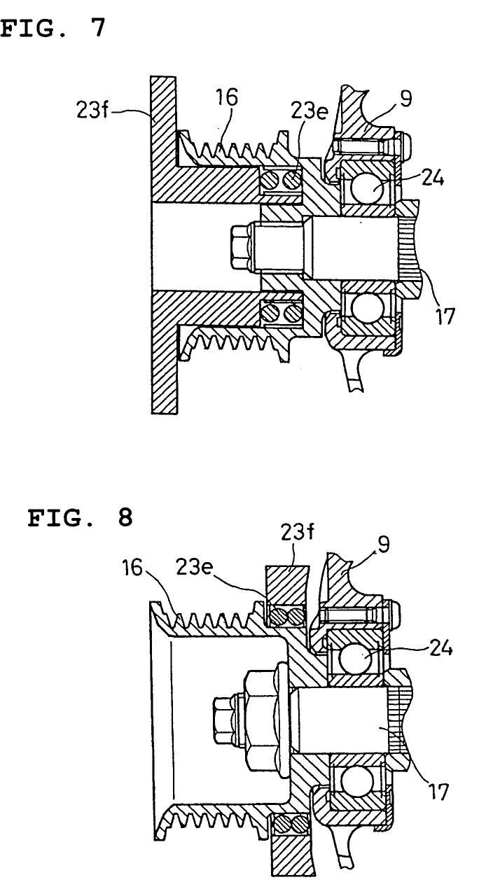

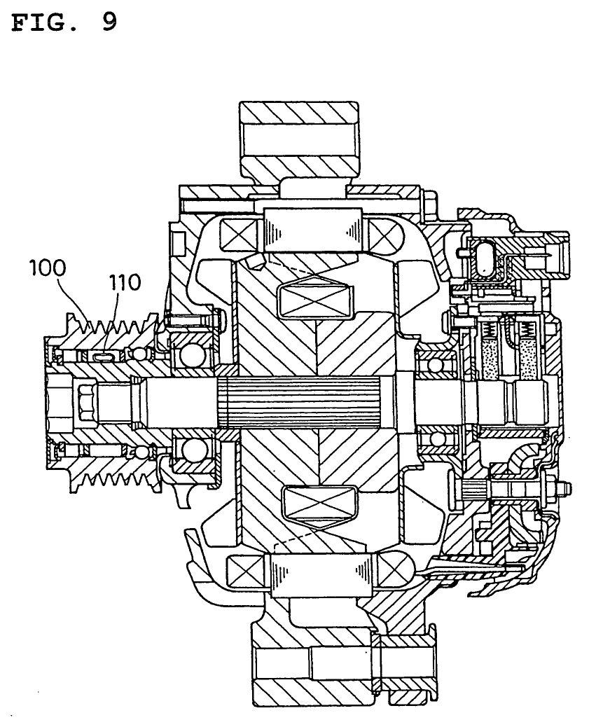

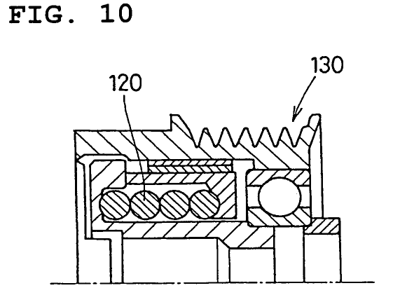

FIG. 7 is a diagram showing a cross section of a portion of an alternator 2 near its pulley 16 of an engine driven system according to a fourth embodiment of the invention. As shown in this figure, the fourth embodiment is characterized in that the dynamic absorber 23 is installed in the pulley 16.

The dynamic absorber 23 is constituted by a spring 23e as an elastic member and an inertia moment member 23f. The inertia moment member 23f is movably fitted in the inner bore of the pulley 16 through the spring 23e.

With this embodiment, it is not necessary to upsize the alternator 2 to provide the alternator 2 with the dynamic absorber 23, since the inner bore of the pulley 16 is used as a space for housing the dynamic absorber 23.

Furthermore, the production costs of the alternator 2 can be made lower, because the alternator 2 can be manufactured only by replacing a conventional pulley with the above described pulley 16, and the manufacturing facility therefore needs only very small change.

In addition, if the dynamic absorber 23 becomes out of order, it does not have a direct effect on the power generating function of the alternator 2.

### Fifth Embodiment

FIG. 8 is a diagram showing a cross section of a portion of an alternator 2 near its pulley 16 of an engine driven system according to a fifth embodiment of the invention. As shown in this figure, the fifth embodiment is characterized in that the dynamic absorber 23 is installed between the pulley 16 and the front housing member 9.

As in the case of the fourth embodiment, the dynamic absorber 23 is constituted by the spring 23e and the inertia moment member 23f. The inertia moment member 23f is movably mounted on the alternator 2 through the spring 23e.

The fifth embodiment provides the same advantages as the fourth embodiment.

The above explained preferred embodiments are exemplary of the invention of the present application which is described solely by the claims appended below. It should be understood that modifications of the preferred embodiments may be made as would occur to one of skill in the art.

What is claimed is:

1. An engine belt-driven system comprising;
a plurality of auxiliaries including a vehicle generator; and
a V-ribbed belt transmitting torque from a vehicle engine to said plurality of said auxiliaries,
wherein said vehicle generator is provided with a dynamic absorber having an inertia moment smaller than an inertia moment of a rotor of said vehicle generator.

2. The engine belt-driven system according to claim 1, wherein said dynamic absorber is mounted to said rotor.

3. The engine belt-driven system according to claim 1, wherein said dynamic absorber is mounted to a pulley of said vehicle generator, said V-ribbed belt running on said pulley.

4. The engine belt-driven system according to claim 1, wherein said vehicle generator is driven with a step-up ratio larger than 2.

5. The engine belt-driven system according to claim 3, wherein an outer diameter of said pulley is smaller than 59 mm.

6. The engine belt-driven system according to claim 1, wherein said engine belt-driven system forms a serpentine belt-driven system.

7. The engine belt-driven system according to claim 1, wherein said dynamic absorber is mounted to at least one of end surfaces of a rotor core of said rotor, said end surfaces being substantially perpendicular to a rotating shaft of said rotor.

8. The engine belt-driven system according to claim 1, wherein said dynamic absorber includes a member creating air resistance when said dynamic absorber rotates.

9. The engine belt-driven system according to claim 8, wherein said member is constituted by fan blades, said fan blades creating a cooling wind used for cooling a winding wound around a stator of said vehicle alternator.

10. The engine belt-driven system according to claim 3, wherein said dynamic absorber is movably fitted in an inner bore of said pulley.

11. A vehicle generator belt-driven by a vehicle engine through a V-ribbed belt comprising:
a pulley on which said V-ribbed belt runs to rotate a rotor of said vehicle generator; and
a dynamic absorber having an inertia moment larger than an inertia moment of said rotor.

12. The vehicle generator according to claim 11, wherein said dynamic absorber is mounted to said rotor.

13. The vehicle generator according to claim 11, wherein said dynamic absorber is mounted to said pulley.

14. The vehicle generator according to claim 11, wherein an outer diameter of said pulley is smaller than 59 mm.

15. The vehicle generator according to claim 11, wherein said dynamic absorber is mounted to at least one of end surfaces of a rotor core of said rotor, said end surfaces being substantially perpendicular to a rotating shaft of said rotor.

16. The vehicle generator according to claim 11, wherein said dynamic absorber includes a member creating air resistance when said dynamic absorber rotates.

17. The vehicle generator according to claim 16, wherein said member is constituted by fan blades, said fan blades creating a cooling wind used for cooling a winding wound around a stator of said vehicle alternator.

18. The engine belt-driven system according to claim 11, wherein said dynamic absorber is movably fitted in an inner bore of said pulley.
